(19) United States
(12) Patent Application Publication
(10) Pub. No.: US 2022/0313008 A1
(43) Pub. Date: Oct. 6, 2022

(54) BEVERAGE FORMING SYSTEM WITH REMOTE USER INTERFACE

(71) Applicant: Keurig Green Mountain, Inc., Burlington, MA (US)

(72) Inventors: Jeffrey Sol Hadden, Arlington, MA (US); Sujatha Kapoor, Acton, MA (US); Philip Ross Hadley, Middlebury, VT (US)

(73) Assignee: Keurig Green Mountain, Inc., Burlington, MA (US)

(21) Appl. No.: 17/640,272

(22) PCT Filed: Sep. 21, 2020
(86) PCT No.: PCT/US2020/051736

§ 371 Date: Mar. 3, 2022

Related U.S. Application Data
(60) Provisional application No. 62/904,797, filed on Sep. 24, 2019.

(51) Int. Cl. A47J 31/52; A47J 31/40; A47J 31/46

(52) U.S. Cl. CPC A47J 31/521; A47J 31/407; A47J 31/46; A47J 31/5253

(57) ABSTRACT

A beverage forming system in which a user interface is adapted to allow a user to control multiple different beverage machines that have different capabilities. A user may be associated with a plurality of different machines, and the user interface may be adapted to adjust display of information to the user and adjust options for controlling operation of a beverage machine based on the set of capabilities of the beverage machine. In some cases, only those stored sets of brew parameters that are compatible with a beverage machine may be displayed for user selection.

### CROSS REFERENCE TO RELATED APPLICATION

This application claims the benefit of U.S. Provisional Application No. 62/904,797, filed Sep. 24, 2019, which is hereby incorporated by reference in its entirety.

### BACKGROUND

### 1. Field of Invention

This invention relates to beverage forming systems, such as coffee brewers that use a liquid to form a coffee beverage.

### 2. Related Art

Beverage forming systems that use a liquid, such as water, to form a beverage are well known. For example, U.S. Patent Application publication 2008/0134902 discloses a beverage forming system that heats water in a reservoir and pneumatically delivers the heated water to a brew chamber for making a coffee drink or other beverage. U.S. Pat. No. 7,398,726 discloses another beverage forming system that delivers heated water from a dispensing tank to a brew chamber by pneumatic forcing of the water from the metering tank. U.S. Patent Application publications 2009/0120299 and 2008/0092746, and U.S. Pat. Nos. 3,511,166, 3,958,502, 4,602,145, 4,263,498 and 8,037,811 disclose other system types in which water in a heater tank or heat exchanger is forced to flow out of the tank and to a beverage making station by introducing unheated water into the tank/exchanger.

### SUMMARY OF INVENTION

In one aspect of the invention, a beverage forming system includes a beverage machine adapted to dispense a beverage and having a set of capabilities for forming beverages. For example, a machine may have capabilities such as a set of different beverage volumes that the beverage machine can dispense (e.g., 6 ounces, 8 ounces, 10 ounces, etc.), a set of different beverage temperatures at which beverages can be dispensed, a set of different beverage strengths at which beverages can be dispensed, an option to dispense the beverage over ice, an option to whip the beverage, an option to mix air with the beverage, a set of different liquid pressures that the beverage machine can use to form a beverage, a capability to automatically deliver beverage material to a beverage forming station, an automatic on/off function, and/or a delayed or scheduled beverage dispense feature (e.g., dispense a beverage at 6 am). The system may also include a remote computer system in communication with the beverage machine and adapted to receive information from the beverage machine and to send information to the beverage machine. For example, a manufacturer of the beverage machine may operate the remote computer system (such as an Internet server) that can receive information from the machine regarding beverages dispensed, machine operating parameters, etc. and can provide information to the machine, such as instructions for dispensing a beverage. The remote computer system may include a memory storing information regarding an association of the beverage machine with a user. For example, a particular user may be associated with a particular beverage machine, e.g., that is located at the user's home or place of work, etc. The system may also include a portable user device having a user interface programmed and adapted to provide information to the user and receive information from the user regarding operation of the beverage machine. As an example, the portable user device may be a smartphone, tablet or other computer device that includes software to implement a user interface by which a user can receive and provide information. The user interface may be in communication with the remote computer system and adapted to enable the user to control operation of a plurality of different beverage machines having different sets of capabilities for forming beverages. Thus, for example, the user interface may be adapted to work with a plurality of different beverage machines, including machines that have a wide variation in capabilities for forming a beverage. The user interface may be adapted to adjust display of information to the user and adjust options for controlling operation of the beverage machine based on the set of capabilities of the beverage machine and the information regarding the association of the beverage machine with the user. As a result, if a user is associated with two or more beverage machines which have different capabilities for forming a beverage, the user interface may adapt its operation for the user based on which machine the user wishes to control. Alternately, if a beverage machine with which a user is associated has an update in capabilities, the user interface can adapt its operation based on the change in capabilities of the machine. These changes in operation of the user interface may be implemented without requiring an update to the software of the user interface.

In some cases, the information regarding association of the beverage machine with the user includes identification information for the beverage machine that uniquely identifies the beverage machine from a plurality of other beverage machines and an indication of the set of capabilities for the beverage machine for forming beverages. As an example, beverage machines may be each assigned a unique code or other identifier that is unique to the machine and different from all other machines, e.g., that are made by a manufacturer, even amongst machines of the same model type or having the same set of capabilities. In some cases, the information regarding association of the beverage machine with the user includes information that uniquely identifies the user from a plurality of other users, e.g., a user name, correspondence address, or other information may uniquely identify a user from all other users.

In one embodiment, the beverage machine is a first beverage machine having a first set of capabilities for forming a beverage, and the system also includes a second beverage machine having a second set of capabilities. The information regarding an association of the beverage machine with the user may include information that associates both of the first and second beverage machines with the user, and the user interface may be adapted to provide a different display of information to the user and different options for controlling operation for each of the first and second beverage machines based on the first and second sets of capabilities.

In some embodiments, the beverage machine uses a set of brew parameters to form a beverage where at least one of the brew parameters is adjustable, and the user interface may be adapted to provide options for adjusting the at least one brew parameter based on the set of capabilities of the beverage machine. For example, the at least one brew parameter may include beverage volume, and the user interface may provide options for adjusting beverage volume that are limited to beverage volumes dispensable by the beverage machine. In some embodiments, the user interface is adapted to display a plurality of stored sets of brew parameters selectable by the user for use in forming a beverage. The sets of brew parameters may be different from each other and at least one of the sets of brew parameters may include a brew parameter having a value that is incompatible with a capability of the beverage machine. The user interface may be adapted to display for selection by the user only the sets of brew parameters including all brew parameters having a value that is compatible with the set of capability of the beverage machine. For example, a user interface may have access to multiple beverage recipes that include parameters such as beverage volume, temperature, ingredients used to form the beverage, etc. Some of the recipes may be incompatible with the beverage machine, e.g., may call for whipping of the beverage where the beverage machine includes no whipper. Where recipes are not compatible with the beverage machine, the user interface may not display those recipes for selection. In some embodiments, selection of a set of brew parameters by a user via the user interface causes the beverage machine to dispense a beverage using the selected set of brew parameters. The stored sets of brew parameters may include user-defined sets of brew parameters that are defined by the user, e.g., a user may store a recipe that includes user preferred parameters such as a favorite beverage volume, temperature, etc. Also, or in addition, the plurality of stored sets of brew parameters may include recommended sets of brew parameters that are defined by an entity that manages the remote computer system. For example, a manufacturer of a beverage ingredient may perform experiments and/or market research to identify an optimal set of parameters for making a beverage using the beverage ingredient. Such recommended sets of parameters may be provided to the user interface for selection by a user.

The user interface may be used to control operation of the beverage machine, either through direct communication between the portable user device, or indirect communication through the remote computer system. For example, the portable user device may be adapted to send user commands provided by a user via the user interface for controlling operation of the beverage machine to the remote computer system, and the remote computer system may be adapted to send commands to the beverage machine based on the user commands.

A beverage machine may be arranged with any suitable set of components, and in one embodiment includes a liquid supply arranged to provide a liquid for forming a beverage, a beverage forming station arranged to hold a beverage material for mixing with the liquid to form a beverage, and a liquid conditioner arranged to heat or cool the liquid that is provided to the beverage forming station. As an example, a liquid supply may include a water storage tank or reservoir, a pump to move water, conduits to carry the flow of water or other liquid, flow meters and/or other sensors to detect liquid, valves for controlling flow, etc. The beverage forming station may hold a beverage capsule that contains a beverage material such as coffee grounds that form a coffee beverage when mixed with water. The liquid conditioner may include a heater tank or inline heater including an electrical resistance heater, or a refrigeration system arranged to cool a liquid provided to the forming station. A control circuit may be arranged to control the liquid supply and the liquid conditioner to operate automatically according to a set of brew parameters to form a beverage using beverage material held by the beverage forming station. As in the examples above, this machine may have a set of capabilities and the user interface may be adapted to provide options to the user to adjust one or more brew parameters to only have a value that is compatible with the set of capabilities of the beverage machine.

In some cases, the control circuit includes a reader to read indicia associated with a capsule held by the beverage forming station, and to determine at least one of the set of brew parameters based on the indicia. For example, some beverage pods may include a barcode, RFID tag or other readable indicia that includes information related to a beverage ingredient in the pod, such as brew parameters to use, an identification of the type of beverage to be made using the pod, etc.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1 is a perspective view of a beverage machine with user interface located at a beverage forming station in an illustrative embodiment;

FIG. 2 is a schematic diagram of a beverage machine connected to a remote computer and user device via a network in an illustrative embodiment;

FIG. 3 is a view of a portable device user interface including adjustable brew parameters for a first beverage machine having a first set of capabilities;

FIG. 4 is a view of a portable device user interface including adjustable brew parameters for a second beverage machine having a second set of capabilities;

FIG. 5 is a view of a portable device user interface including selectable sets of brew parameters for the first beverage machine;

FIG. 6 is a view of a portable device user interface including selectable sets of brew parameters for the first beverage machine; and

FIG. 7 is a schematic diagram of components of a beverage machine in an illustrative embodiment.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. For example, aspects of the invention are described with reference to specific user interface arrangements, but aspects of the invention are not limited to the user interface arrangements described herein. Thus, aspects of the invention are not intended to be construed narrowly in view of the illustrative embodiments. In addition, it should be understood that aspects of the invention may be used alone or in any suitable combination with other aspects of the invention.

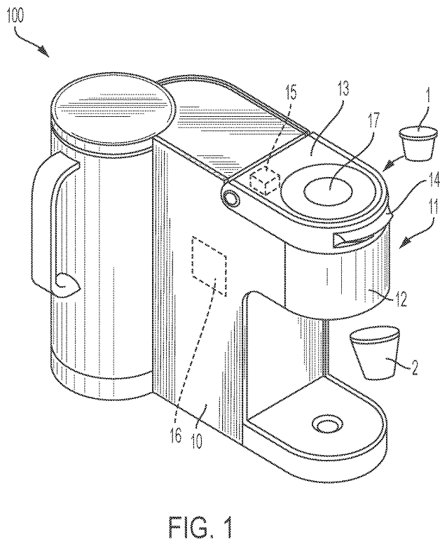

FIG. 1 shows a perspective view of a beverage machine 100 in an illustrative embodiment that may be used in embodiments of the invention. For purposes herein, the beverage machine 100 may be used to form any suitable beverage, such as tea, coffee, other infusion-type beverages, carbonated beverages, beverages formed from a liquid or powdered concentrate, soups, juices or other beverages made from dried materials, or others. As will be appreciated, the beverage machine may produce hot and/or cold beverages. In the illustrative embodiment of FIG. 1, the machine 100 is arranged to form coffee or tea beverages (e.g., as a beverage brewer). As is known in the art, a beverage capsule, such as beverage capsule 1, may be provided to the machine 100 and used to form a beverage that is dispensed into a container 2, such as a user's cup, carafe or other. The capsule 1 may be manually or automatically provided to a beverage forming station 11 of the beverage machine 100. For example, the beverage forming station 11 may include a capsule holder 12 that is exposed to receive the capsule 1 when the user (or machine controller) operates a handle or other actuator 14 to open the forming station 11, e.g., by moving a lid or other cover 13 with respect to the capsule holder 12. With the capsule 1 placed in the capsule holder 12, the capsule holder 12 and lid 13 may be moved relative to each other to at least partially enclose the capsule 1, e.g., so that water or other precursor liquid can be introduced into the capsule 1 to form a beverage. For example, with the capsule 1 held in the beverage forming station 11, the capsule 1 may be pierced to form inlet and outlet openings through which water or other precursor liquid enters the capsule 1 and beverage exits the capsule 1, respectively. U.S. Pat. No. 8,361,527 describes a capsule and a system for introducing liquid into the capsule that may be used in an embodiment of this invention, and is hereby incorporated by reference in its entirety.

A user may receive information from, and/or provide information to, the beverage machine 100 via a user interface 17 on the machine housing 10, which may include a display, buttons, switches, touch screen and/or other elements for information display and reception. As described in more detail below, the user interface 17 may be interacted with by a user to adjust one or more brew parameters used by the machine 100 to form a beverage. Such parameters may include a beverage volume, temperature, strength, time period, carbonation level, a time in the future to dispense a beverage (a scheduled brew or dispensing), and any other suitable setting used by the machine to form a beverage. Adjusting a “strength” of a beverage may be performed in different ways, such as using additional beverage material to form a beverage than a standard amount, using less water to form a beverage than a standard amount, using a higher water or steam pressure to form a beverage than a standard level (e.g., espresso coffee is made using higher pressure water or steam than drip-type coffee), and others. In the illustrative embodiment below, adjusting the “strength” of a beverage is done by adjusting a flow rate of water to the beverage forming station: a slower flow rate provides longer contact time between water and beverage material, thereby increasing a “strength” of the beverage dispensed. However, features of the invention may be employed with any technique to adjust beverage strength.

The machine 100 may use a set of one or more brew parameters to form a beverage, and a set of brew parameters may include beverage-specific parameters that are definable for each particular beverage and/or configuration-type parameters that each have a value which is generally used for all or a large number of beverages formed by the machine 100. The beverage-specific parameters and/or configuration type parameters may be adjusted by a user, although if adjustable, may be adjusted in different ways. For example, a user may select or at least have the ability to adjust beverage-specific parameters for each beverage. Examples of this type of parameter include beverage volume and/or strength, although others are possible. In some embodiments, the user interface 17 may have one or more buttons or other features that enable a user to select a desired value for beverage volume, strength, etc. each time a beverage is formed and then instruct the machine 100 to start a beverage formation process, such as by pressing a “brew button” or otherwise providing instruction to start beverage formation. In response, the machine 100 will dispense the beverage using the set of brew parameters.

While a user may also have the ability to adjust configuration-type parameters, the process for adjusting such parameters may be different than for beverage-specific parameters, e.g., because configuration-type parameters are generally not intended to be adjustable for each beverage formation process. Examples of this type of parameter are beverage temperature and a pressure of liquid used to form a beverage. (It should be understood, however, that this is not an exhaustive list, and beverage temperature and liquid pressure may be beverage-specific parameters in some implementations. The same is true of beverage volume and strength, which may be configuration-type parameters in some machines 100.) In many coffee brewers, the machine 100 is configured to heat water to a particular beverage temperature for delivery to a beverage forming station, e.g., for mixing with beverage ingredients. (As used herein, a “beverage temperature” refers to a temperature of liquid that is used to form a beverage and/or a temperature of a dispensed beverage. The actual temperature of a dispensed beverage may be the same, or different (e.g., lower) than the temperature of liquid used to form a beverage, e.g., because in some cases ingredients at the beverage forming station may cool the liquid to at least some extent. Thus, it should be understood that “beverage temperature” refers to a target heating or cooling temperature for a water heater or other liquid conditioner that provides liquid for forming a beverage, as well as a target or intended temperature of dispensed beverage.) For example, many coffee brewers are configured to deliver water to a beverage forming station that is at a predefined temperature of around 195 degrees F. Some coffee brewers allow a user to adjust the target heating or beverage temperature, e.g., to compensate for high altitude locations where a brewer is used, and to do so, a user may be instructed to interact with the user interface 17 in a non-standard way. As merely one example, a user may be instructed to simultaneously press two user interface buttons that are not generally pressed at the same time, e.g., an illumination on/off button and a 10 ounce beverage volume button. This may cause the machine 100 to enter a mode in which the user can adjust the beverage temperature. Thus, configuration-type parameters may be adjustable by a user, but not in a standard way and not intended for adjustment for each beverage formation cycle.

In some cases, a beverage machine 100 may be arranged to define a set of brew parameters that at least initially have default values for each beverage formation process. As an example, each time the machine 100 is employed to make a beverage, values for beverage parameters may be selected and used for forming a beverage unless changed by a user. Often, configuration-type parameters will have a same default value for each beverage formation process, and beverage-specific parameters may as well. Default settings for brew parameters may be retrieved from memory or otherwise determined. In some cases, at least some default settings for brew parameters may be determined by a controller based on at least one characteristic identified from a capsule 1 that is to be used to form a beverage. For example, as shown schematically in FIG. 1, the beverage forming station 11 includes a reading device 15 arranged to capture an image of a portion of the capsule 1 or otherwise read or identify a characteristic of the capsule 1. In some cases, the capsule may include one or more machine readable indicia such as alphanumeric text, a logo, a barcode (e.g., a 2D or 3D barcode), RFID tag, inductive element, magnetic strip or other element, optically sensed element (e.g., visible or invisible text, graphics, color), physical structures or other indicia arranged to indicate a characteristic of the capsule. Characteristics indicated by indicia on the capsule 1 may include a manufacturer name or location, a brand name or logo, a type of beverage ingredient in the capsule or beverage to be made using the capsule, instructions and/or machine settings for use in preparing a beverage using the capsule, an authentication code or other information that permits the machine 100 to operate using the capsule, etc. Based on a characteristic of the capsule 1 identified by the controller 16, the controller 16 may determine default values for one or more brew parameters, at least some of which may be adjustable by a user before or while a beverage is dispensed.

In some cases, a reading device 15 and controller 16 may fail to identify a characteristic of a capsule held by the forming station of the machine 100. This may occur for various reasons, such as there may be no capsule 1 held by the forming station 11, a capsule 1 held by the forming station 11 includes no readable indicia (e.g., a capsule may include no readable text, barcode, etc.), and/or a capsule 1 may have readable indicia such as a barcode, but the reading device 15 may fail to properly read the indicia (e.g., because the indicia is obscured by dirt or other foreign material, is damaged, has a format that the reading device 15 cannot decode, etc.). In such a case, the controller 16 may adjust one or more brew parameters to define a way that a subsequent beverage is dispensed. Also, in some cases, a brew parameter adjusted by the controller 16 in response to failure to identify a capsule characteristic may not be adjustable by a user. This may be done for various reasons, including providing a rapid dispense of hot water, ensuring that a capsule is used to form a beverage at an appropriate temperature or other conditions, help ensuring that a capsule is used to form a beverage with reduced chance of brewing problems, and others. For example, failure of the controller 16 to identify a capsule characteristic may indicate that no capsule is present in the forming station 11. As a result, the controller 16 may set a strength parameter to a “weak” setting by which the machine 100 dispenses hot or cooled water to the forming station at a relatively high flow rate and without any intermittent or pulsed delivery that might be used for higher strength settings. That is, the absence of a capsule in a beverage forming station may be interpreted as indicating that a user wishes to have the machine 100 dispense plain hot water that is not mixed with any beverage ingredient at the forming station 11. As a result, a “strength” setting may have no usefulness in such a situation, and the controller 16 may adjust a strength setting for the beverage dispensing operation to a weak or other appropriate setting that causes hot water to be dispensed at a relatively rapid flow rate. Even if a user has previously set or attempts to adjust the strength brew parameter to something different (e.g., where strength is a configuration-type parameter), the controller 16 may adjust the strength parameter to the suitable “weak” or other setting that corresponds to a relatively rapid flow rate for dispensing.

As another example, a beverage machine 100 may be arranged to operate with a wide variety of different capsules, including capsules for use in forming cool or chilled beverages as well as hot beverages. Some of these capsules may be adapted for use with a particular water temperature or at least water below a threshold temperature, e.g., capsules intended to be used to make a chilled beverage may be arranged to work with water at temperatures of 120 degrees F. or less. If a controller 16 cannot identify a characteristic of a capsule 1, e.g., indicia on the capsule 1 cannot be properly read, the controller 16 may adjust one or more brew parameters to account for capsule characteristics, such as an inability to withstand high temperatures. Thus, the controller 16 may adjust a beverage temperature to an appropriate setting, such as 120 degrees F. or less, when a capsule 1 characteristic cannot be identified. As noted above, the controller 16 may adjust configuration-type brew parameters (such as beverage temperature) or beverage-specific parameters in response to failure to identify a capsule characteristic, and adjustment by the controller 16 may not be overridden or otherwise changed by a user. For example, a controller 16 may be adapted to adjust a beverage volume to be no more than 12 ounces if a characteristic of a capsule 1 cannot be identified. This may be done to help ensure that a beverage that meets consumer taste requirements is dispensed. For example, a beverage machine 100 may be arranged to dispense beverages up to 24 ounces in volume, but beverages having a volume of 14-24 ounces may only be dispensed when specially configured capsules 1 are used. Otherwise, capsules 1 most commonly used with the machine 100 may be arranged to form a beverage of no more than 12 ounces. If the controller 16 cannot identify a characteristic of a capsule 1, the controller 16 may adjust a beverage volume to be 12 ounces (assuming the capsule is the more commonly used capsule configured for 12 ounce beverages or less), and this brew parameter setting may not be adjustable by a user, at least to a value above 12 ounces.

As another example, a machine 100 may be arranged to form beverages by delivering water to a forming station 11 at different pressures, e.g., relatively high pressure for use with espresso-type capsules and relatively low pressure for drip-type coffee capsules. As will be appreciated, capsules arranged to be used with relatively low pressure water or steam may not be capable of withstanding pressures suitable for forming espresso coffee. If a controller 16 cannot identify a characteristic of a capsule 1, the controller 16 may adjust a fluid pressure brew parameter to be no more than a threshold, such as a pressure that is at or below a level that drip-type coffee capsules can withstand. This way, if a drip-type capsule is in a forming station 11 when a characteristic of the capsule cannot be identified, the capsule will not be exposed to unsuitably high pressures.

In some embodiments, the controller 16 may be arranged to use a default set of brew parameters to form a beverage when a characteristic of a capsule is identified. That is, while a user may be able to adjust one or more of the values for the default set of brew parameters, absent such adjustment, the controller will use the default set to form a beverage using a capsule which has a characteristic identified. A default set of brew parameters may be determined by the controller 16 using a stored set of parameter values (e.g., in a database that corresponds to a type of capsule held by the forming station 11), parameter values obtained from indicia on a capsule 1, parameter values from a user's preference settings, etc., as well as from combinations of such sources. For example, the default set of brew parameters may include a beverage temperature that is obtained from a configuration-type parameter database store of the controller 16 as well as a beverage volume that is obtained from a user's preferences, which also may be stored in memory of the controller 16 or elsewhere. If a characteristic of the capsule cannot be identified, one or more of the brew parameters in the default set may be adjusted by the controller 16, e.g., by retrieving one or more brew parameters of an adjusted set of parameters from memory of the controller 16 which are used instead of a corresponding brew parameter in the default set. An adjusted brew parameter determined by the controller 16 may be used instead of a user-set brew parameter, whether a configuration-type parameter or beverage-specific parameter.

Note that while the functionality of the user interface 17 discussed above is implemented on a beverage machine 100, the same or similar functionality may be implemented on another device, such as a user's smartphone, tablet or other device where the other portable device is arranged to display control information to a user and accept user commands to adjust a brew parameter or for other machine operation control. As an example, an application operating on a user's smartphone may provide information and receive commands from a user in a same or similar way as that described above so that a user can control operation of a beverage machine 100. Thus, a user may select between multiple stored sets of brew parameters, adjust one or more brew parameters, and cause a beverage machine 100 to dispense a beverage using the adjusted parameters via the smartphone or other remote device. The smartphone or other remote device may communicate directly with the controller 16 of the beverage machine 100, e.g., via a local network, or indirectly with the controller 16, e.g., via a remote server or other device and a network such as the Internet.

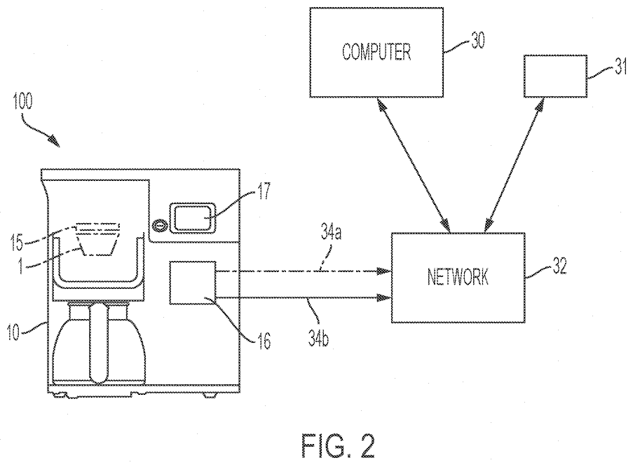

FIG. 2 shows an illustrative beverage forming system by which a beverage machine 100 may communicate with a remote computer 30 (such as a computer server operated by a manufacturer of the machine 100) and a portable user device 31 (such as a smartphone) via a network 32. In some embodiments, the controller 16, remote computer 30 and user device 31 include a communications interface arranged to receive and send information with respect to the machine 100, such as brew parameter information, operating instructions, messages for display to a user, capsule data (e.g., capsule image data or other indicia), etc. In some embodiments, the beverage machine 100 is configured to read capsule indicia and send beverage preparation parameters to the remote computer 30 and/or user device 31 (e.g., via the controller 16), e.g., capsule indicia data and beverage preparation parameters may be sent to the remote computer 30 and/or user device 31 before, during or after a beverage is dispensed. Sending such information before dispensing may allow a user and/or remote server to make adjustments or recommendations for adjustments to brew parameters before dispensing. Sending such information during or after dispensing may allow the user and/or remote server to track capsule use, determine when beverage are dispensed and using which brew parameters, etc., and thus may enable the user and/or server to enhance the overall beverage experience. In some embodiments, the beverage preparation parameters recorded and/or sent by the beverage machine include the day of the week, the time of day, the size (e.g., volume) of beverage prepared, the temperature of the water, the strength of beverage formed (e.g., strong, medium, weak), the type of beverage formed, and/or other apparatus settings (e.g., power settings, whether air was introduced into the precursor liquid during beverage formation, a carbonation level of the beverage, a location of the beverage machine during preparation of the beverage or an identity of a user associated with preparation of the beverage). The controller 16 may be configured to decode the capsule indicia, e.g., to allow sending of characteristics of a capsule to a user device 31 or remote server 30. As will be appreciated, in such embodiments, the imaging device may include an image decoder (e.g., a barcode reader, optical character recognition software, and/or other image analysis capability). The beverage machine may 100 have one-directional communication with the remote computer 30 and/or user device 31 via the network 32. That is, the machine 100 may communicate with the remote computer 30 and/or user device 31 but may not receive communications therefrom. The remote computer 30 and/or user device 31 may have bi-directional communications ability with the machine 100, and/or other devices connected to the network 30, e.g., the computer 30 may be arranged to send communications directly to a user device 31 (e.g., to a user's telephone or e-mail.). The beverage machine 100 also may be arranged to have bi-directional communication with the remote computer 30 and/or user device 31 (e.g., sending communications to and receiving communications from the remote computer). For example, the remote computer 30 may send information to the machine 100 regarding a message that is displayed on a user interface 17 on the machine 100. In other embodiments, the remote server 30 may send decoded indicia (e.g., a beverage preparation parameter) back to the machine 100, which may then use the parameter to prepare the beverage. The beverage machine 100 may be connected to the network 32 via a wireless connection 34a and/or a wired connection 34b (e.g., via an Ethernet cable).

The remote computer 30 may be configured to track the number of capsules consumed by the user or machine 100 (e.g., the number of capsule used and/or the types of capsules used). In some embodiments, the remote computer may track consumption by tracking capsule and/or brew parameter information that the beverage machine sends to the computer. The remote computer may be configured to determine a user's need for capsule replenishment based on the user's consumption and on past purchase history. In some embodiments, the remote computer determines when a user is in need of capsule replenishment by determining when the user's current supply of capsules falls below a threshold amount (e.g., less than a week's worth of capsules). In some embodiments, the remote computer determines the user's current capsule supply (e.g., a remaining number of unused capsules) by comparing the number of capsules purchased by the consumer (e.g., purchased from the beverage machine manufacturer, such as via an e-commerce website) and the number of capsules consumed by the user. The remote computer also may determine whether the number of remaining capsules has fallen below the threshold amount. The remote computer may run an algorithm to make such a calculation.

In some embodiments, the portable user device 31 may have a user interface programmed and adapted to provide information to the user and receive information from the user regarding operation of the beverage machine. In some cases, the user device user interface may be adapted to enable the user to control operation of a plurality of different beverage machines that each have different sets of capabilities for forming beverages. For example, different beverage machines may have different abilities to form beverages, e.g., some coffee brewers may dispense beverages having a volume of 6 ounces to 24 ounces, while another coffee brewer may be able to dispense only beverages having a volume of 10 ounces to 14 ounces. In other cases, a coffee brewer may be able to use water or steam having pressures of 1-2 psi to 150 psi, while another coffee brewer may be capable of using water pressures of only 1-2 psi. The user device user interface may be adapted to adjust its display of information to the user and adjust options for controlling operation of a beverage machine based on the set of capabilities that the beverage machine has. This adjustment in operation of the user device user interface may be made based on information regarding an association of the user with one or more beverage machines. Such association information may be stored in memory of the remote computer 30, e.g., which is established when a user installs a beverage machine 100 at a home or other location.

The set of capabilities that beverage machines can have may include a variety of adjustable and non-adjustable features or parameters, including a set of different beverage volumes that the beverage machine can dispense, a set of different beverage temperatures at which beverages can be dispensed, a set of different beverage strengths at which beverages can be dispensed, an option to dispense the beverage over ice, an option to whip the beverage, a set of carbonation levels for a beverage, an option to mix air with the beverage, a set of different liquid pressures that the beverage machine can use to form a beverage, a capability to automatically deliver beverage material to a beverage forming station, an automatic on/off function, and a delayed or scheduled beverage dispense feature. This list is not exhaustive, and beverage machines may have other capabilities (or not) that cause a user device user interface to adjust its operation, e.g., display of information and options for controlling beverage machine operation.

Information that associates a beverage machine with a user may include information for the beverage machine that uniquely identifies the beverage machine from a plurality of other beverage machines, whether of the same or different type or model. For example, a manufacturer of beverage machines may sell different models of beverage machines where the different models have different sets of capabilities for forming a beverage. However, beverage machines of the same model may have the same set of capabilities. Association information may uniquely identify a beverage machine from all other beverage machines, even those of the same model, or may uniquely identify the beverage machine from machines of a different model type but not of the same model. The association information may include an indication of the set of capabilities for the beverage machine for forming beverages, e.g., the remote computer 30 may store information that indicates what capabilities a beverage machine 100 has so that a user device 31 user interface can adjust operation accordingly. The association information may also include information that uniquely identifies the user from a plurality of other users. Thus, each user may be uniquely identified with respect to one or more beverage machines, or machines having a particular set of capabilities.

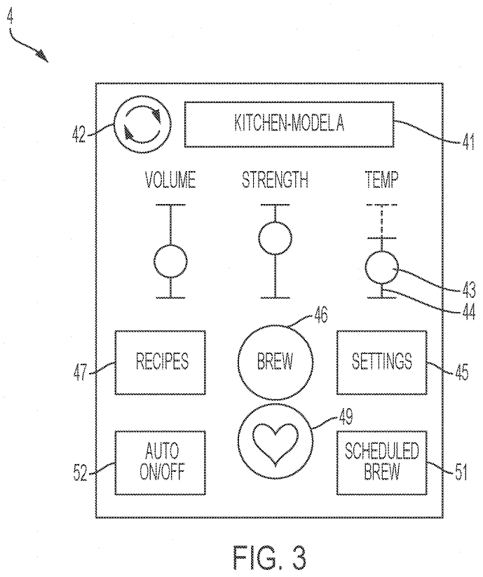

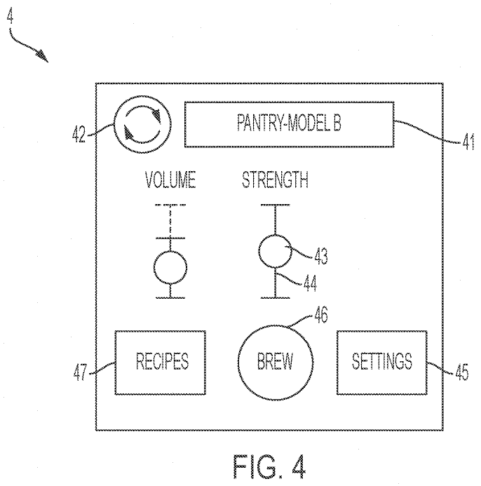

As discussed above, beverage machines may use a set of brew parameters to form a beverage and at least one of the brew parameters may be adjustable. A user device user interface may provide options to the user for adjusting at least one brew parameter, and may do so based on the set of capabilities of the beverage machine with which the user is associated. For example, FIG. 3 shows a user interface 4 that can be provided by a portable user device 31 for a particular beverage machine 100. The user may cause the user interface 4 to be presented on the user device 31, e.g., by clicking or otherwise activating an application (e.g., a set of stored instructions executable by a data processor) on the user device 31. Alternately, a user's interaction with the beverage machine 100, such as placement of a capsule 1 in a forming station 11, may cause the user interface 4 to be presented. The user interface 4 may display information regarding the identity of the beverage machine 100 associated with the user, e.g., in this case “Kitchen—Model A” in machine identifier field 41. Of course, any name, label or other identifier information may be provided for an associate beverage machine 100. In this case, a user named the beverage machine 100 with a label that indicates the location of the machine 100 (the “Kitchen”) as well as the model of the machine (“Model A”). This may help a user confirm the proper machine is being controlled via the user interface 4 in cases where the user is associated with more than one machine. Since the user interface 4 operation is controlled based on the association of a user with a particular beverage machine, the user interface 4 may provide the user with the ability to control another associated beverage machine, e.g., by pressing a button 42 that may cause the user interface 4 to display a list of beverage machines that the user is associated with and can select, e.g., by clicking, pressing or otherwise interacting with the user interface 4. FIG. 4 shows a situation where a user has pressed the machine change button 42 and selected a different machine that is associated with the user, i.e., having the label “Pantry-Model B” indicated in the machine identifier field 41.

The user interface 4 in FIG. 3 presents the user with the option of adjusting three brew parameters, i.e., volume, strength and temperature, although other parameters may be presented with an option for adjustment or at least an indication of the value to be used to form a beverage. In this case, brew parameters are adjustable using a slider element 43 that is movable along a track 44, e.g., movement of the slider element 43 up and down on the track 44 may adjust a corresponding brew parameter value up and down. A numerical indication (e.g., a number corresponding to the set volume or temperature), icon or other information may be displayed as well. Of course, brew parameters may be adjusted in other ways, such as by a user typing in a value, clicking up/down arrows, selecting a displayed value, etc. As noted above, options for brew parameter control may be adjusted on the user interface 4 based on a set of capabilities of the beverage machine 100. In the example of FIG. 3, the beverage machine 100 has the ability to use different volume, strength and temperature values, and so a user may adjust them. The limits and/or increments for the adjusted values may depend on the beverage machine set of capabilities, e.g., maximum and/or minimum volume, strength, temperature, etc. values may be adjusted based on the capabilities of the machine 100. In this example, the machine 100 is not capable of employing temperature settings at the extreme upper end of the track 44, and so this portion of the track 44 is shown in dashed line and the slider element 43 cannot be moved by a user into this upper region of the track 44. Other approaches may be taken, however, e.g., the maximum value or limit for the temperature setting in the FIG. 3 user interface 4 may correspond to the upper end of the track 44 for one brewer that has an upper temperature limit of 197 degrees F., as well as for another brewer that has an upper temperature limit of 190 degrees F. In cases where a brew parameter is not adjustable for a beverage machine, the user interface 4 may adjust operation to disallow adjustment of the parameter. For example, in the example of FIG. 4, the beverage machine 100 “Pantry-Model B” does not have the capability of adjusting a beverage temperature and so temperature is not displayed on the user interface 4. This approach may be taken for beverage-specific parameters, as well as for configuration-type parameters. Alternately, a user may take a different approach for adjusting configuration-type parameters than beverage-specific parameters, such as by pressing a settings button 45, which causes the user interface 4 to present an interface (e.g., including a slider arrangement as in FIG. 3, or other) that allows the user to adjust a beverage temperature or other configuration-type parameter.

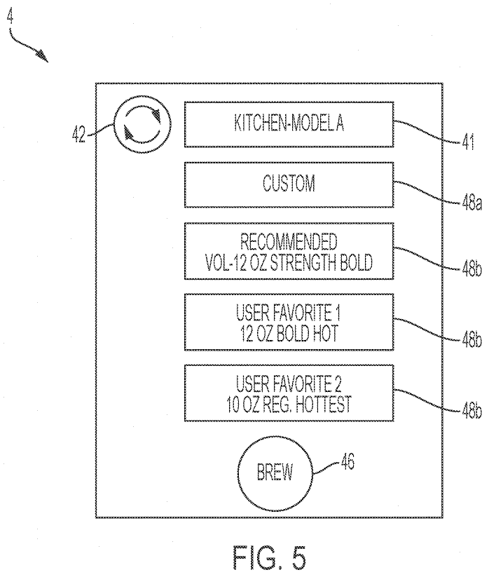

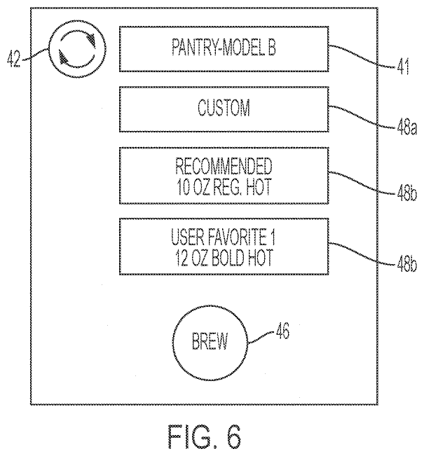

Brew parameters may initially have a default value, as discussed above, and one way those default values can be defined at least in part is for a user to select from one of a plurality of stored sets of brew parameters. A user may cause the user interface 4 to present a plurality of sets of selectable brew parameters by pressing a recipe button 47 or otherwise interacting with the user interface 4 to cause a listing of brew parameter sets, e.g., like that in FIG. 5. The displayed sets of brew parameters selectable by the user are different from each other (e.g., have at least one different value for a brew parameters) and only those sets of brew parameters including all brew parameters having a value that is compatible with the set of capabilities of the beverage machine are displayed. That is, sets of brew parameters that have a brew parameter with a value that is incompatible with a capability of the beverage machine are not displayed. This way, a user cannot select a set of brew parameters that cannot be implemented by the beverage machine. In the example of FIG. 5, three sets of brew parameters 48b are displayed, along with a “custom” set 48a. Selecting the custom set 48a may present a user interface 4 like that in FIG. 3 where brew parameters have a default value but a user can set brew parameters in any way. Selecting one of the other sets of brew parameters 48b will cause selection of the corresponding brew parameters, e.g., by highlighting of a set 48b. The displayed sets of brew parameters 48b may include a summary of at least some parameter values, e.g., indicating volume, strength and temperature in qualitative and/or quantitative terms, so a user can quickly assess which set may be desired. If a user selects a different beverage machine that has a different set of capabilities, the sets of brew parameters that are selectable by a user will change based on whether sets of brew parameters have parameter values that are compatible with the machine's capabilities. For example, in FIG. 6, a user has changed to associated machine “Pantry-Model B” and as a result, one of the brew parameter sets is no longer displayed because the “Pantry-Model B” machine cannot use that set of parameters, e.g., because it includes a beverage temperature that is higher than the machine can use. The examples in FIGS. 5 and 6 show sets of brew parameters that are “recommended” or defined by a manufacturer or other entity associated with the beverage machine and/or an entity that manages the remote computer 30, as well as user “favorites” that are defined by a user. A user may define a favorites set of brew parameters by suitably setting parameter values and then pressing a “favorites” button 49 (see FIG. 3) which causes the user interface 4 to save the set of brew parameters. A user may be enabled to name or otherwise associate a label with the set of brew parameters, e.g., User Favorite 3.

In some embodiments, the sets of brew parameters displayed for selection and/or an order in which sets are displayed may be adjusted depending on various factors. For example, a user's favorite set of brew parameters may be one that a user prefers or usually uses in the afternoon, but does not use in the morning. Thus, if the current time of day is afternoon, that particular set of brew parameters may be presented at the top of the list. As another example, a coffee roaster may have specially designed a set of brew parameters for a particular type of coffee. If a beverage machine identifies indicia on a capsule that corresponds to that particular type of coffee (or a user indicates this type of coffee is to be made), the user interface 4 may display the specially designed set of brew parameters at a top of the list or otherwise highlight it in some way. Other options for adjustment in display and selection of sets of brew parameters are possible, e.g., a set of brew parameters that is particularly popular in a region of a country may be highlighted or specially presented for selection, or a set of brew parameters that a user often selects could be specially presented, etc.

With brew parameters set as desired, a user may cause the beverage machine 100 to dispense a beverage by pressing a start or “brew button” 46. This may cause the user device 31 to send a command to the remote computer 30 to cause dispensing to begin, and the computer 30 may in response send a command to the beverage machine 100 to start beverage dispensing. Alternately, a user could interact with the user interface 4 to cause dispensing of the beverage to occur at some future time, e.g., by selecting a “scheduled brew” button 51 in FIG. 3, which allows a user to define a time of day that the beverage should be dispensed. Note that while the associated machine in FIG. 3 has a scheduled brew feature, and thus the scheduled brew button 51 is displayed, the associated machine in FIG. 4 does not and so the scheduled brew button 51 in FIG. 4 is not included. The associated machine in FIG. 3 also has the ability to set an automatic on/off time, and so includes an auto on/off button 52 that allows a user to set a time of day when the machine 100 will automatically turn on or off. The associated machine in FIG. 4 does not have this capability and so the user interface does not include this button. These are merely a few examples of different machine capabilities, and others may be included with different machines and cause different operation of the user interface 4.

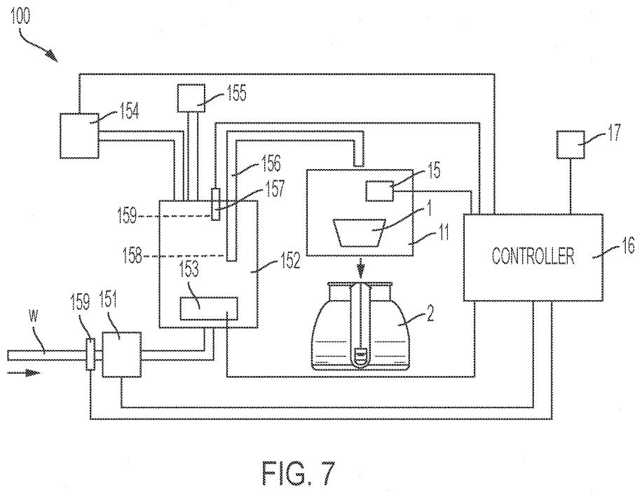

FIG. 7 shows a schematic block diagram of various components that may be included in a beverage machine 100 in one illustrative embodiment. Those of skill in the art will appreciate that a beverage forming apparatus 100 may be configured in a variety of different ways, and thus aspects of the invention should not be narrowly interpreted as relating only to one type of beverage forming apparatus. In this embodiment, water or other precursor liquid may be provided by a liquid supply to mix with a beverage material at a beverage forming station 11. The beverage material (such as coffee grounds, tea leaves, a powdered drink mix, etc.) may be provided in a capsule 1, or not, and beverage produced by mixing the liquid with the beverage material may be dispensed into the container 2 via a beverage outlet.

The liquid supply in this embodiment controls the volume of liquid provided to the beverage forming station 11 by filling a tank to a liquid dispense level 159 and then pressurizing the tank 152 by way of an air pump 154 so that liquid in the tank 152 is forced out of the conduit 156 to the beverage forming station 11. The volume of liquid delivered to the beverage forming station 11 is equal to the volume in the tank 152 between the liquid delivery level 159 and a post-delivery level 158 at a bottom of the conduit 156 in the tank 152. Since there is one delivery level 159 in this embodiment, one volume can be provided to the beverage forming station 11. However, two or more delivery levels may be used.

In this embodiment, the liquid supply provides liquid to the tank 152 via a valve 151 that is coupled to a source W. The source W may have any suitable arrangement, e.g., may provide liquid from a removable or fixed storage tank, a mains water supply or other source. Thus, in some cases, the liquid provided to the tank 152 may vary in temperature by a wide degree depending on various factors, such as time of year, a temperature of a room in which the machine 100 is located, etc. For example, if the source W is a reservoir that is filled by a user, the temperature of liquid in the reservoir may vary between room temperature (e.g., if liquid sits in the reservoir for an extended time) and a cooler temperature (e.g., if the reservoir has just been filled with water that is dispensed from a tap).

To provide liquid to the tank 152 in this embodiment, the valve 151 is controlled by the control circuit 16 to open and close to provide a desired volume of liquid to the tank 152. For example, if the tank 152 is empty or at the post-dispense level 158, the valve 151 may be opened until a conductive probe or other liquid level sensor 157 provides a signal to the control circuit 16 that indicates when liquid arrives at the dispense level 159. In response to the level sensor 157 detecting liquid at the sensor 157, the control circuit 16 may close the valve 151. Of course, other arrangements are possible, such using a pump to move liquid from a storage reservoir to the tank 152.

Although in this embodiment the liquid level sensor includes a conductive probe capable of contacting liquid in the tank 152 and providing a signal (e.g., a resistance change) indicative of liquid being present at respective dispense level 159 in the tank 152, the liquid level sensor may be arranged in other ways. For example, the sensor may include a microswitch with an attached float that rises with liquid level in the tank 152 to activate the switch. In another embodiment, the liquid level sensor may detect a capacitance change associated with one or more liquid levels in the tank, may use an optical emitter/sensor arrangement (such as an LED and photodiode) to detect a change in liquid level, may use a pressure sensor, may use a floating magnet and Hall effect sensor to detect a level change, and others. Thus, the liquid level sensor is not necessarily limited to a conductive probe configuration. Moreover, the liquid level sensor may include two or more different types sensors to detect different levels in the tank. For example, a pressure sensor may be used to detect liquid at a dispense level (e.g., complete filling of the tank 152 may coincide with a sharp rise in pressure in the tank 152), while a conductive probe may be used to detect liquid at the other dispense level 159.

Further, a liquid level sensor need not be used to fill the tank to the dispense level 159. Instead, other techniques may be used to suitably fill the tank 152, such as opening the valve 151 for a defined period of time that is found to correspond to approximate filling of the tank 152 to the desired level. Of course, other arrangements for providing liquid to the tank 152 are possible, such as by a pump (e.g., a centrifugal pump, piston pump, solenoid pump, diaphragm pump, etc.), gravity feed, or other, and the way by which the tank is filled to the dispense level 159 may depend on the technique used to provide liquid to the tank. For example, control of a volume of liquid provided to fill the tank 152 to the dispense level 159 may be performed by running a pump for a predetermined time, detecting a flow rate or volume of liquid entering the tank 152 (e.g., using a flow meter), operating a pump for a desired number of cycles (such as where the pump is arranged to deliver a known volume of liquid for each cycle), detecting a pressure rise in the tank 152 using a pressure sensor, or using any other viable technique.

Liquid in the tank 152 may be heated by way of a heating element 153 whose operation is controlled by the control circuit 16 using input from a temperature sensor or other suitable input. Also, the tank 152 may be arranged as an inline or continuous flow heater that has a relatively small volume, e.g., a tube with associated heating element to heat liquid in the tube. Of course, heating of the liquid is not necessary, and instead (or additionally) the apparatus 100 may include a chiller to cool the liquid, a carbonator to carbonate the liquid, or otherwise condition the liquid in a way that alters the volume of liquid in the tank 152. (Generally speaking, components of the liquid supply that heat, cool, carbonate or otherwise condition liquid supplied to the beverage forming station 11 are referred to as a “liquid conditioner.”)

In this embodiment, liquid may be discharged from the tank 152 by an air pump 154 operating to force air into the tank 152 to pressurize the tank and force liquid to flow in the conduit 156 to the beverage forming station 11. Since the conduit extends downwardly into the tank 152, the volume of liquid delivered to the forming station 11 is defined as the volume in the tank 152 between the dispense level 159 and the bottom end of the conduit 156. Again, liquid may be caused to flow from the tank 152 to the beverage forming station 11 in other ways. For example, a pump may be used to pump liquid from the tank 152 to the forming station 11, a pump could force liquid into the tank 152 which causes liquid in the tank to move to the forming station 11, liquid may be allowed to flow by gravity from the tank 152, and others. A volume of liquid delivered from the tank to the forming station 11 may be controlled based on a volume of liquid forced into the tank 152, which may be detected by a flow meter, pump cycles, etc. A vent 155, which can be opened or closed to vent the tank 152, may be provided to allow the tank 152 to be filled without causing a substantial rise in pressure in the tank 152 and to allow liquid to be delivered from the tank 152 by pressurizing the tank using the air pump 154. In this embodiment, the vent 155 is actually not controlled by the control circuit 16, but remains always open with an orifice of suitable size to allow venting for filling of the tank 152, and air pressure buildup in the tank 152 to allow liquid delivery. Other flow control features may be provided as well, such as a check valve or other flow controller that can prevent backflow in the conduit between the source W and the tank 152, or between the tank 152 and the beverage forming station 11.

The beverage forming station 11 may use any beverage making ingredient, such as ground coffee, tea, a flavored drink mix, or other beverage medium, e.g., contained in a capsule 1 or not. Alternately, the beverage forming station 11 may function simply as an outlet for heated, cooled or otherwise conditioned water or other liquid, e.g., where a beverage medium is contained in the container 2. Once liquid delivery from the tank 156 to the station 11 is complete, the air pump 154 (or other air pump) may be operated to force air into the conduit 156 to purge liquid from the beverage forming station 11, at least to some extent.

Operation of the valve 151, air pump 154 and other components of the apparatus 100 may be controlled by the control circuit 16, e.g., which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 17), communication buses or other links, a display, switches, relays, triacs, or other components necessary to perform desired input/output or other functions. As discussed above, the user interface 17 may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A beverage forming system comprising:
a beverage machine adapted to dispense a beverage, the beverage machine having a set of capabilities for forming beverages;
a remote computer system in communication with the beverage machine and adapted to receive information from the beverage machine and to send information to the beverage machine, the remote computer system including a memory storing information regarding an association of the beverage machine with a user; and
a portable user device having a user interface programmed and adapted to provide information to the user and receive information from the user regarding operation of the beverage machine, the user interface in communication with the remote computer system and adapted to enable the user to control operation of a plurality of different beverage machines having different sets of capabilities for forming beverages, the user interface adapted to adjust display of information to the user and adjust options for controlling operation of the beverage machine based on the set of capabilities of the beverage machine and the information regarding the association of the beverage machine with the user.

2. The system of claim 1, wherein the set of capabilities of the beverage machine includes at least one of the following: a set of different beverage volumes that the beverage machine can dispense, a set of different beverage temperatures at which beverages can be dispensed, and a set of different beverage strengths at which beverages can be dispensed.

3. The system of claim 1, wherein the set of capabilities of the beverage machine includes at least one of the following: an option to dispense the beverage over ice, an option to whip the beverage, an option to mix air with the beverage, a set of different liquid pressures that the beverage machine can use to form a beverage, a capability to automatically deliver beverage material to a beverage forming station, an automatic on/off function, and a delayed or scheduled beverage dispense feature.

4. The system of claim 1, wherein the information regarding association of the beverage machine with the user includes identification information for the beverage machine that uniquely identifies the beverage machine from a plurality of other beverage machines and an indication of the set of capabilities for the beverage machine for forming beverages.

5. The system of claim 4, wherein the information regarding association of the beverage machine with the user includes information that uniquely identifies the user from a plurality of other users.

6. The system of claim 1, wherein the beverage machine is a first beverage machine having a first set of capabilities for forming a beverage, further comprising a second beverage machine having a second set of capabilities, and wherein the information regarding an association of the beverage machine with the user includes information that associates both of the first and second beverage machines with the user, and wherein the user interface is adapted to provide a different display of information to the user and different options for controlling operation for each of the first and second beverage machines based on the first and second sets of capabilities.

7. The system of claim 1, wherein the beverage machine uses a set of brew parameters to form a beverage where at least one of the brew parameters is adjustable, and wherein the user interface is adapted to provide options for adjusting the at least one brew parameter based on the set of capabilities of the beverage machine.

8. The system of claim 7, wherein the at least one brew parameter includes beverage volume, and the user interface provides options for adjusting beverage volume that are limited to beverage volumes dispensable by the beverage machine.

9. The system of claim 7, wherein the user interface is adapted to display a plurality of stored sets of brew parameters selectable by the user for use in forming a beverage, the sets of brew parameters being different from each other and at least one of the sets of brew parameters including a brew parameter having a value that is incompatible with a capability of the beverage machine, the user interface adapted to display for selection by the user only the sets of brew parameters including all brew parameters having a value that is compatible with the set of capability of the beverage machine.

10. The system of claim 9, wherein selection of a set of brew parameters by a user via the user interface causes the beverage machine to dispense a beverage using the selected set of brew parameters.

11. The system of claim 9, wherein the plurality of stored sets of brew parameters includes user-defined sets of brew parameters that are defined by the user.

12. The system of claim 9, wherein the plurality of stored sets of brew parameters includes recommended sets of brew parameters that are defined by an entity that manages the remote computer system.

13. The system of claim 1, wherein the portable user device is adapted to send user commands provided by a user via the user interface for controlling operation of the beverage machine to the remote computer system, and the remote computer system is adapted to send commands to the beverage machine based on the user commands.

14. The system of claim 1, wherein the beverage machine includes:
a liquid supply arranged to provide a liquid for forming a beverage;
a beverage forming station arranged to hold a beverage material for mixing with the liquid to form a beverage;
a liquid conditioner arranged to heat or cool the liquid that is provided to the beverage forming station; and
a control circuit arranged to control the liquid supply and the liquid conditioner to operate automatically according to a set of brew parameters.

15. The system of claim 14, wherein the user interface is adapted to provide options to the user to adjust one or more brew parameters to only have a value that is compatible with the set of capabilities of the beverage machine.

16. The system of claim 14, wherein the control circuit includes a reader to read indicia associated with a capsule held by the beverage forming station, and to determine at least one of the set of brew parameters based on the indicia.

17. The system of claim 1, wherein the portable user device is incapable of communicating directly with the beverage machine to control dispensing of a beverage.
